(19) United States
(12) Patent Application Publication
(10) Pub. No.: US 2004/0240515 A1
(43) Pub. Date: Dec. 2, 2004

(54) Optical end-point detector for a hygrometer

(76) Inventors: David Egan, Hudson, NH (US); Jeffrey Hawkins, Middleton, MA (US); Napoleon Baeuvais, Hyde Park, MA (US)

Correspondence Address: BANNER & WITCOFF, LTD., 28 STATE STREET, 28th FLOOR, BOSTON, MA, 02109-9601, US

(21) Appl. No.: 10/485,406

(22) PCT Filed: Aug. 2, 2002
(86) PCT No.: PCT/US02/24596

Related U.S. Application Data
(60) Provisional application No. 60/310,105, filed on Aug. 3, 2001.

(51) Int. Cl. G01K 1/16

(52) U.S. Cl. 374/120

(57) ABSTRACT

The invention is a new intelligent means of condensation detection on a condensation surface (3). An imaging system (1) and imaging analysis system will replace the current optical system consisting of a transmitter and a detector. The image system is mounted in the sensor sample cavity (21) such that it can view the condensation surface. The imaging system establishes a base image from the condensation surface that has been heated above the surrounding dew point as to ensure that there is no condensation present on the condensation surface. As the condensation surface begins to cool, the software interrogates the images of it and detects the presence of condensation as a change from the reference image. Data produced by the imaging system would be used in a real time control loop to seek out the dew point and reach steady state conditions.

### PRIORITY CLAIM

This application claims priority from commonly owned U.S. Provisional Patent Application Serial No. 60/310,105, filed 03 Aug. 2001, the disclosure of which is hereby incorporated herein by reference.

### BACKGROUND OF THE INVENTION

This invention relates in general to a hygrometer device that includes electrical circuitry employed to detect moisture condensate on a surface via optical techniques. Specifically, the invention apparatus and methods provide rapid and accurate measurement of moisture levels in gases throughout a broad range of water vapor pressures.

The principle of measuring dew or frost point using a chilled mirror hygrometer has been in place for nearly sixty years. The initial sensors required the user to detect the presence of condensation using a sight glass. As technology evolved, emitter and detector optical systems were built into the sensors as a means of detecting the condensation and providing closed loop control for dew or frost point measurement. (Dulk, U.S. Pat. No. 3,112,648) This method was a big improvement over the existing technology but still contained opportunity for improvement. It is the purpose of this invention to address areas of improvement with the current means of condensation detection and to create a technology gap between itself and existing art.

Dew or frost point hygrometers are frequently used to measure the moisture content in a gas sample. Typical hygrometers contain a reflective condensation surface, cooled and temperature controlled by thermoelectric, cryogenic, or mechanical refrigeration methods. The condensation or formation of dew or frost on this surface is then detected via optical methods, generally consisting of a light source and a photosensitive detector positioned in ways to distinguish changes in the reflected light from the condensation surface. The optical detection devices are connected to electronic circuitry, whereby a signal is generated to control the surface cooling/heating apparatus at a preset detector threshold level. The detector threshold level corresponds to a degree of reflected light and hence a predetermined thickness of frost or dew condensate on the cooled surface. In this state, an equilibrium condition exists between the water vapor pressure in the sample gas and the water and/or ice layer on the condensate surface at a specific surface temperature, defined as the dew/frost point temperature. A temperature detection device, typically a resistance temperature detector such as a platinum resistance thermometer or thermocouple, is positioned local to the condensation surface to measure the condensation surface equilibrium dew/frost point temperature.

In these hygrometers, the condensation surface cooling and temperature control apparatus, reflected light detection devices, and electrical control circuitry comprise a thermo-optical servo control system which maintains the predetermined optical detector threshold limit, and hence an equilibrium condensate layer thickness and corresponding dew/frost point temperature.

Four basic components or sub-systems comprise chilled surface hygrometers: a thermally conductive condensation surface; a method for cooling and controlling the temperature of the condensation surface, a temperature sensor or detector with supporting signal conditioning electronic circuitry, and an optical detection system with circuitry suitable for closed loop control of the condensation surface cooling/heating sub-system.

Most hygrometers employ a reflective surface (mirror) as the condensation surface in order to maximize the amount of reflected light available to the photosensitive detector. Typical condensation surfaces are made from highly thermally conductive materials such as copper, which are surface treated to maximize surface temperature uniformity, via rhodium plating for example. Mirrors in the existing art have also been manufactured from platinum or stainless steel for corrosion resistance or with gold or sapphire coatings for additional performance improvements. (Cooper U.S. Pat. No. 5,507,175). In addition to these condensation surfaces used within optical condensation detection methods, other condensation detection systems and surfaces, such as the measurement of capacitance or other electrical properties of the condensation surface, the propagation velocity of an acoustic wave traveling across the condensation surface, or the resonant frequency of a vibrating crystal functioning as the condensation surface exist in known art. The intention of this invention is to improve on the condensation detection mechanism in each of the above mentioned existing art.

Prior art of the condensation surface cooling/heating sub-system utilized in chilled surface hygrometry consists of thermoelectric Peltier junction heat pumps, cryogenic techniques using cryogens such as liquid nitrogen or chlorofluorocarbons (Buck, U.S. Pat. No. 5,460,450), or mechanical vapor-compression refrigeration. The most common method of cooling the condensate surface is through one or more Peltier junctions, through which the surface temperature is lowered or raised as a function of applied voltage and current polarity. Typical cryogenic sub-systems maintain condensate surface temperatures via control of the conduction path from the cryogen fluid to the condensation surface, coupled with a means of heating the surface such as electrical resistance heating within the condensation surface conduction path. Typical mechanical refrigeration systems cool and control the temperature of the condensation surface via expansion of a compressed refrigerant fluid in thermal contact with the condensation surface, coupled with a means of heating the condensation surface such as an electrical resistance heater in the condensation surface conduction path.

The most common prior art method employed in optical hygrometer detection sub-systems includes light emitting diodes and photodetectors. Typically, these arrangements include coordinated pairs of light sources and photodetectors, whereby the temperature effects on light source emission and detector efficiency can be minimized. One pair provides an output to the control circuitry proportional to the reflected light from the condensation surface, while the other pair provides a reference output utilized to correct temperature induced changes. Further enhancements to this basic method include the use of selected wavelengths of light sources, such as specific bands in the ultraviolet, infrared, or microwave spectra and the use of fiber optics transmission techniques. Other prior art in condensation surface hygrometer detection methods include the usage of non-optical means such as surface acoustical wave devices, resonating crystal structures, and capacitive/resistive components.

There are several well know opportunities for improvement with this current means of condensation detection. These opportunities all revolve around the fact that the optical system provides only one source of information; change in light level at the detector.

The effects of contamination in the sample gas stream on the condensation surface can present considerable obstacles for condensing hygrometers. Foreign material on the condensation surface can disrupt the equilibrium condition present between the water/ice on the condensation surface and the vapor pressure of water in the sample gas stream. In addition, contamination on the condensation surface can present differences in the reflected light, which can be interpreted by the detection sub-system as the presence of an “artificial” dew and or frost layer thereby inducing errors in the dew or frost point measurement.

In response to contamination, there have been several methods proclaimed in prior art designed to minimize these effects (Coriolis U.S. Pat. No. 2,893.237, Bisberg U.S. Pat. No. 3,623,356, Harding U.S. Pat. No. 4,216,669, Dosoretz U.S. Pat. No. 4,629,333, Schwiesow U.S. Pat. No. 5,227,636). The earliest existing art describes flooding the mirror with condensate to absorb soluble contaminants followed by rapid heating to evaporate the contaminants. Other existing art describes flooding the condensation surface and forcing the contaminants to coalesce and then evaporating the condensate to redistribute the contaminants into localized areas rather than being uniformly distributed across the mirror surface. Additional existing art presents dual optical devices with wavelengths tuned to be adsorbed either by the condensation or contamination, mechanical wipers or compressed gas nozzles employed on the condensation surface to physically remove contamination, and “dry ice” (CO₂) cleaning via contaminate solution and mild surface abrasion.

In addition to the errors contributed by condensation surface contamination, considerable dew or frost point inaccuracies can exist in condensing hygrometers due to ambiguities resulting from dew or frost phase discrimination. It is well know that liquid water can exist below its bulk freezing point to temperatures as low as −40° C. due to the well understood principles of undercooling/supercooling and are governed by the laws of Gibb's free energy. Most detection sub-systems in the existing art lack effective methods in distinguishing which phase is present on the condensation surface. Since the saturation vapor pressure of water is dependent on which phase is present in the equilibrium condition governed by the Goff-Gratch formulation, dew or frost point errors are likely to occur in this dew/frost point region.

In prior art, cycling chilled mirror hygrometers (Cooper, Protimeter U.S. Pat. No. 5,507,175) combat this effect by continually heating the condensation surface above the preceding dew point temperature reading and then cooling back down to reform a dew layer. This process is always measuring the liquid phase of condensation, as the device is not at the dew/frost point temperature long enough for the condensation to change phase into the solid state. By always knowing the condensation is in the liquid phase, the error associated with phase differences is eliminated. However, the process of continual cycling makes it impractical for low frost point measurements as the process of heating and cooling and reforming a condensation layer at low frost points becomes time prohibitive.

Further complications exist in condensation surface hygrometry due to system response time and detection sensitivity. At low frost point temperatures (−60° C. and below), the relatively low sensitivity of the detection methods impede the formation and recognition of an predetermined frost layer thickness. The sensitivity of typical optical detection systems require the condensation of a mass of frost on the condensation surface large enough to produce a measurable shift in the output signal in order to achieve a practical signal to noise ratio and make repeatable, practical measurements. In prior art, attempts have been made to reduce the long equilibrium response time at these low dew points by introducing a quantity of water vapor into the sensor cavity to seed the condensation surface with moisture, thereby increasing the rate of surface condensation. The introduction of water vapor onto the condensation surface does help to begin the growth of the initial dew layer, but it has also been know to cause oscillations in the control loop.

A similar response time problem occurs in the region where supercooled water can exist (0° C. to −40° C.). When measuring in this region, the initial condensation layer is in the form of liquid water. Because the equilibrium phase of water below 0° C. is solid, the condensation is not in its equilibrium phase. Since the current detection system cannot distinguish between the liquid and solid phase of the water, the system must wait the time required for this layer to freeze into ice to make an accurate frost point measurement. One means of ensuring the phase of the condensation is through the understanding that the principle of undercooling is kinetic in nature, that it is a transient effect. Given enough time, the supercooled liquid water will always change into the equilibrium solid phase allowing an accurate dew point measurement to be made. This phase transition time makes the response time of the current optical systems impractical.

Another area for improvement in the existing art is in the manner that the information available on the condensation surface is presented to the user of the device. In most existing-art the information is presented to the end user in the form of an alpha numeric dew or frost point reading or some other form representing a quantity of moisture present in a volume of air. This has typically been accomplished by presenting this value with the use of industry standard LED's, LCD's or other tape of display products. As users realized the need for additional information regarding the state of the condensation surface the concept of providing visual feedback to the user was presented in the existing art (Leone, U.S. Pat. No. 2,979,950). Other existing art offered the option of adding a microscope to allow the end user an enhanced view of the condition of the condensation surface. The concept presented in this invention is one of utilizing an imaging sensor and analysis system for data extraction of the condensation surface. This concept has the added feature of presenting the condition of the condensation surface in a video image that can also be presented to the end user to visually observe the condition of the condensation surface.

The last two issues with the current optical sub-system are related to the manufacturing of the optical systems and the condensation surface of the hygrometers.

In order to get the best signal to noise ratio, it is critical that the emitter and the detector are optically aligned with the condensation surface. If optical alignment is not obtained, the reflected signal at the detector is reduced and the accuracy and response time of the system will be adversely affected. In addition, optical systems in some existing art require two sets of components a measurement pair and a reference pair to minimize the effect of temperature common with these type of devices. Since the applications for hygrometers require a wide range of operating temperatures, the signals from the optical components need to be matched across this temperature range to ensure that thermal drift does not trigger false measurements.

The condensation surface in most of the existing art uses a highly polished metal mirror as the condensation surface that allows maximum reflectance of the emitted light to reach the detector in the dry state. The manufacturing costs associated with this type of component can be extensive and require a high cost of continued support. In addition, if the condensation surface were to be damaged during routine maintenance or operation (i.e. scratched or pitted), the signal received by the detector is reduced and the system eventually would require service.

### SUMMARY OF THE INVENTION

The present invention provides a new, intelligent means of detecting the presence and the state of condensation on a condensation surface. One main objective of this invention is to improve the optical system typically found in the existing art, which typically consists of an emitter and a photodetector with an imaging system. Contrary to the prior art systems, the imaging system of the present invention has the ability to provide an abundance of information that is not available with the prior art systems.

In a preferred embodiment an imaging system is mounted to the underside of a pressure cover above a condensation surface within a direct line of sight, forming a sensing system. The output from this imaging system is electrically connected with an analysis system. As the condensation surface is cooled below the dew point of the sample gas being sent into or through the sample cavity, moisture will begin to condense out of the gas stream onto the condensation surface. Images of the condensation surface are continually being processed by the imaging system. As the condensation grows, the imaging system outputs signals to the control loop to heat and cool the condensation surface to maintain a predetermined level of dew. As this predetermined dew level is reached, a reading from the temperature sensor is taken and is reported as the dew point.

This method of condensation detection is superior to prior art technologies because it eliminates the issues mentioned above by using various analysis algorithms available with imaging analysis systems to provide multiple sources of information about the condition of the condensation surface. It eliminates the issues associated with supercooled water. By “training” the detection system to distinguish the visual differences between liquid and frozen condensation, the actual dew or frost point can be reported without the errors associated with phase differences.

The new detection system can also be “trained” to seek out particulate contamination. If the system suspected the presence of contamination, it would heat up the surface above the local dew point and compare this image with a “reference” image. In tie heated state, differences between the images would be interpreted as contamination and could trigger a service routine. This new detection system also has a much higher signal to noise ratio and greater sensitivity that will allow for a decrease in response time. This increased sensitivity will allow the instruments to control on a “thinner” condensation layer so the time required for growing a dew layer would be reduced thereby allowing for greater frost point measurement range.

Also, this new detection system will eliminate the need for precise focusing and alignment required during manufacturing of the prior art systems. Once installed, the present imaging system allows for image cropping so that the precise region of interest on the condensation surface can be interrogated. Lastly, the surface finish of the condensation surface will no longer be as critical. The detection systems of the prior art tend to rely on a highly polished surface to achieve maximum signal to noise ratio and even minor scratches on the condensation surface will reduce performance. Using the imaging system of the present invention, the condensation surface can be periodically heated to remove condensation and a new reference image can thus be acquired. By continually establishing such a new reference surface, scratches that inevitably occur during operation can be referenced out.

It is one objective of this invention to make improvements to the optical system used in dew point hygrometers as a means of condensation detection. These improvements improve the performance of the device by: eliminating the error associated with the inability of the optical systems of current art hygrometers to distinguish the phase difference between liquid and solid condensation, decreasing the response time of the system both in the supercooled water region (0° C. to −40° C.) as well as the region of low dew points (−60° C. and below), introducing a method of contamination detection to reduce the errors associated with the presence of contamination and the maintenance of the hygrometer. Additional improvements are provided in the manufacturing process of the hygrometers by, for example, minimizing the need for thermal compensation of the measuring and reference optical component sets, minimizing the process of achieving proper optical alignment of the measuring and reference optical sets, minimizing the need for the manufacture and upkeep of a reflective condensation surface.

Another objective is to provide a system that will allow for repeatably resolving the area of the condensation surface into a matrix of smaller areas and deliver the ability to discern the condition of each of the smaller areas of the surface.

Another objective is to provide a system that is capable of discerning the presence of condensation on the condensation surface down to the range of single microns.

Another objective is to deliver a system that will be able to increase the range of measurement of the existing art by increasing the sensitivity of typical optical systems present in the existing art especially at dew points in the area of −60° C. and below.

Another objective is to deliver a system that will present to the user a real time visual representation of the condition of the condensation surface.

Another objective is to deliver a system that will be able to determine the phase of the condensation present on the condensation surface.

Another objective is to deliver a system that will be able to eliminate the measurement errors, slow response time and software adjustments present in the existing art due to the inability to determine the phase of the condensation present on the condensation surface.

Another objective is to provide a system that will allow for increased performance by altering the size, shape, material and surface characteristics of the condensation surface.

Another objective is to deliver a system that simplifies the manufacturing of the existing art by minimizing the effects of temperature associated with the optical systems of the existing art.

Another objective is to deliver a system that simplifies the manufacturing of the existing art by minimizing the precise manufacturing and optical assembly associated with the optical systems of existing art.

Another objective is to deliver a system that simplifies the manufacturing of the existing art by minimizing the need for the manufacturing required for producing the reflective mirror condensation surface associated with the existing art.

Another objective is to provide a system that will reduce the maintenance required with the existing art by minimizing the care required to maintain the highly reflective condensation surface present in the existing art.

Another objective is to provide a system with improved response time due to the increased sensitivity of the imaging system over the optical system of the existing art. In addition the increased sensitivity will allow for reduced maintenance due to the decreased mass of condensation on the condensation surface thus reducing the potential for contaminants present on the condensation surface.

These and other objectives of the invention will become more apparent from the detailed description to follow when considered with the accompanying drawings that illustrate a preferred embodiment of the invention.

Thus, in one embodiment, the present invention is directed to an image processing apparatus for gas analysis, comprising:

a central body containing a chamber having two ends, with a condensation surface located at one end of the chamber, the central body having at least one input channel to the chamber for introduction of a gas to be analyzed;

an image-capturing device located at the opposed end of the chamber from the condensation surface; and

a processing device for analyzing captured images of the condensation surface.

Preferably, in this image processing apparatus, the condensation surface is a mirror with a reflective surface facing the lens of the image-capturing device. Advantageously, the processing device is a microprocessor/microcomputer. In certain embodiments, the apparatus further comprises an automated control system.

In certain preferred embodiments, the image processing apparatus further comprises a temperature sensor located near the condensation surface. Advantageously, the temperature sensor is contained in a base assembly located beneath the central body. More preferably, the temperature sensor is located beneath the condensation surface.

In certain preferred embodiments, the image processing further comprises a heat pump located near the temperature sensor and the condensation surface. Advantageously, the heat pump is contained in a base assembly located beneath the central body. More preferably, the heat pump is located beneath the temperature sensor.

In certain preferred embodiments, the image processing apparatus further comprises a cooling plate. Advantageously, the cooling plate is located beneath the heat pump.

In certain preferred embodiments, the image processing apparatus has the image-capturing device mounted to a pressure cover, thereby permitting the apparatus to be pressurized—either above atmospheric pressure or below atmospheric pressure (vacuum). Advantageously, the pressure cover forms an airtight seal when engaged with the central body. In certain preferred embodiments the pressure cover further comprises a sealed electrical connector through which output wires of the image-capturing device pass.

In certain preferred embodiments, the image processing apparatus further comprises inputs from the temperature sensor. Advantageously, the image processing apparatus further comprises inputs from the image-capturing device. More preferably, the image processing apparatus further comprises outputs to the image-capturing device and the heat pump.

One especially preferred embodiment of the image processing apparatus for gas analysis, according to this invention comprises:

a central body containing a chamber having two ends, with a condensation surface located at one end of the chamber, the condensation surface having a reflective surface facing the lens of the image-capturing device, the central-body having at least one input channel to the chamber for introduction of a gas to be analyzed; an image-capturing device located at the opposed end of the chamber from the condensation surface, the image-capturing device being mounted to a cover, the cover forming a seal when engaged with the central body, the cover having a sealed electrical connector through which output wires of the image-capturing device pass;

a temperature sensor located near the condensation surface,

a heat pump located near the temperature sensor,

a cooling plate located near the heat pump, and

a processing device for analyzing captured images of the condensation surface.

Another especially preferred embodiment of the image processing apparatus for gas analysis, according to this invention comprises:

a central body containing a chamber having two ends, with a condensation surface having a top side and an underside, the condensation surface being located at one end of the chamber, the central body having at least one input to the chamber for introduction of a gas to be analyzed, the condensation surface having a reflective mirrored surface facing the lens of the image-capturing device;

an image-capturing device located at the opposed ends of the chamber from the condensation surface, the image-capturing device being mounted to a pressure cover that forms a seal when engaged with the central body, the pressure cover having a sealed electrical connector through which output wires of the image-capturing device pass;

a base assembly having a temperature sensor, a heat pump and a cooling plate, the temperature sensor being located beneath the underside of the condensation surface, the heat pump being located beneath the temperature sensor, the cooling plate being located beneath the heat pump; and

a processing device for analyzing captured images of the condensation surface, the processing device having inputs from the temperature sensor and image-capturing device, the control system having outputs to the image-capturing device and the heat pump.

### BRIEF DESCRIPTION OF THE DRAWINGS

FIG. 1 is a cross sectional view of a typical chilled mirror hygrometer sensor with a preferred embodiment of the image detection system of the present invention installed.

FIG. 2 is a flow chart describing the start up process of the image system and describes the steps that the analysis system takes on the initial measurement sequence.

FIG. 3 is a flowchart presenting the integration of the output from the image system and the processing performed by the analysis system.

FIG. 4 describes one concept used to handle the presence of contamination on the condensation surface.

### DETAILED DESCRIPTION OF THE PREFERRED EMBODIMENT

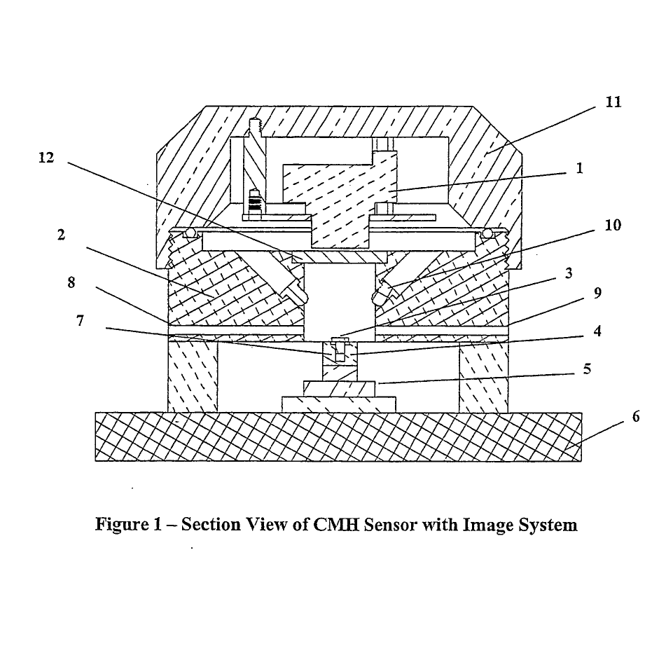

FIG. 1 provides a cross section of a typical dew point hygrometer configured with the proposed imaging system 1, sample cavity 2, condensation surface 3, temperature sensor 4, heat pump 5 and the cooling plate 6.

The imaging system is composed of an imaging sensor, for example, a CCD or CMOS sensor with required support electronics. The output of the imaging system, for example, a raw digital or analog video signal is electronically delivered to a control circuit which processes the output for the purpose of detecting the presence and condition of condensation. The imaging system 1 is mounted internal to a pressure cover 11 in such a manner that a line of sight is established with the condensation surface 3, for example directly above the condensation surface. The imaging system may be sealed from the sample cavity in an environmentally controlled volume by an optically clear disk, for example a glass disk 12. The condensation surface 3, for example a highly reflective mirror, made from highly thermally conductive material, for example copper and surface treated to achieve a uniform surface temperature, for example rhodium. Mirrors in the existing art have also been manufactured from platinum or stainless steel for corrosion resistance or from gold or sapphire surface for additional performance improvements. (Cooper, U.S. Pat. No. 5,507,175) The mirror is positioned in the sample cavity 2 to ensure that the sample gas presented for measurement is in direct contact with the mirror 3.

The sample cavity 2 is configured to provide a pressure tight volume to allow the sample gas an inlet and an outlet for continuous measurement, for example 8 and 9. The mirror 3 has the additional feature of being removable for service, for example by machining a thread on the surface opposite the condensation surface. This thread is mated with a mirror block 7 which is made from a highly thermally conductive material, for example copper and maintains intimate thermal contact with the mirror but remains sealed from the sample gas. The mirror block is configured with a temperature measurement device 4, for example a platinum resistive element to allow for the temperature of the mirror 3 to be determined. The mirror block 7 is also in thermal contact with a heat removal device, for example a Peltier thermoelectric cooler (TEC) 5 that allows the temperature of the mirror 3 to be changed as required. The TEC 5 is in direct thermal contact with a second heat removal device, for example a liquid cooled cooling plate 6 that is manufactured from highly conductive material, for example copper or brass and allows for the heat removed from the mirror 3 by the TEC 5 to be removed from the system. The TEC 5, the output from the imaging system 1 and the temperature device 4 are part of an electro-optic control circuit which makes adjustments to the TEC 5 based on the output of the imaging system 1. Once the correct signals are received from the imaging system 1, for example a predetermined shift in output due to the presence of condensation on the mirror 3, then the temperature of the mirror 3 is read from the temperature device 4 and reported as the dew point or frost point of the sample gas.

Also shown in FIG. 1, the imaging sensor within the imaging system 1 requires that the sample cavity 2 be fitted with an illumination source 10 for example an emitter operating in the visible or IR spectrum. This illumination source provides the imaging sensor within the imaging system to respond to changes in the light level at the mirror 3 within the sample cavity 2. The wavelength and orientation of the emitter are selected to allow for optimum sensitivity at the imaging sensor within the imaging system 1. One means of accomplishing this is to mount the emitter 10 so that the light delivered to the mirror 3 is directed away from the viewing area of the imaging sensor within the imaging system 1 when the mirror 3 is in a condensation free state, for example 45°. In this orientation the imaging system 1 will present the data describing the dry condensation surface 3 as a dark area. In this configuration, at power up, the control circuit will cool the mirror 3 due to the output data from the imaging system 1. Condensation will form on the surface of the mirror 3 once the mirror surface is lowered below the dew point of the sample gas. The presence of condensation on the mirror surface will cause a portion of the directed light from the emitter to be directed at the imaging sensor within the imaging system causing a change in the output signal. The process described above may be accomplished in a number of unique geometric orientations between the light source 10, the imaging system 1 and the mirror 3. Each orientation for the purpose of causing a change in the light level observed by the imaging sensor within the imaging system due to the presence or lack of presence of condensation of the mirror.

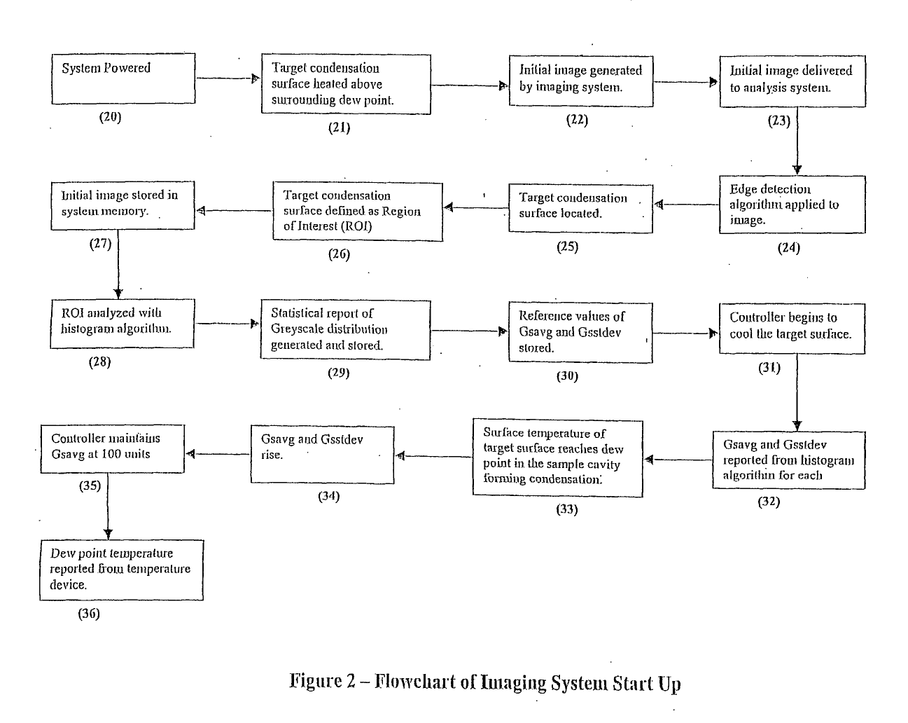

FIG. 2 describes the start up process of the imaging system and the subsequent collection of reference information. Upon power up 20, the condensation surface is heated by the Peltier heat pump to ensure that the temperature of the condensation surface is above the dew point in the sample cavity 21. After the condensation surface has been heated, an initial reference image from the imaging system is being delivered to the analysis system 22 & 23. This initial image is used to define the location of the condensation surface within the image by applying an analysis algorithm, for example an edge detection algorithm 24. The edge detection algorithm operates by defining deviations in the brightness reading for each pixel within the generated image. The brightness level of each pixel is described using an 8-bit greyscale. A pixel that is receiving no light and is completely black has a greyscale value of 0 while a pixel that is saturated with light and is completely white has a greyscale value of 255. Once located 25, the perimeter of the condensation surface is geometrically defined and the area inside the perimeter of the condensation surface is defined as the region of interest (ROI) for all subsequent analysis 26. Immediately following the definition of the ROI a reference image of the region is stored in the system memory for subsequent comparison 27. Once defined, the ROI of subsequent images is analyzed using an analysis algorithm, for example a histogram algorithm 28. The histogram algorithm creates a statistical report of the brightness level of each pixel within the ROI 29. Primary values of interest are extracted from the statistical report, for example the average and standard deviation of the greyscale distribution, GSavg and GSstdev respectively. These statistical values of the greyscale distribution of the ROI of the initial image and are stored as reference values 30. Typical values for a dry condensation surface are low, for example 40 to 60 for GSavg and 15 to 25 for GSstdev.

Once the reference image and the required reference statistical values are stored, the controller for the heat pump begins to cool down the condensation surface 31. As the condensation surface begins to cool, the image system is producing images at a high rate, for example 30 images per second. The ROI for each image is analyzed with the histogram. The histogram algorithm reports the GSavg and GSstdev for each image 32. When the surface temperature of the condensation surface reaches the dew point in the sample cavity, condensation begins to form on the condensation surface 33. The formation of condensation on the condensation surface causes the GSavg and GSstdev to rise 34. When the GSavg rises above a control level, for example 100 to 120 GSavg units, the control loop begins to heat the condensation surface to slow down the continuing growth of condensation on the condensation surface. The controller changes the temperature of the condensation surface to maintain a control value of typically 100 to 120 GSavg units 35. When the GSavg reaches this steady state condition, the temperature of the condensation surface is read from the temperature device as the dew point of the environment in the sample cavity 36.

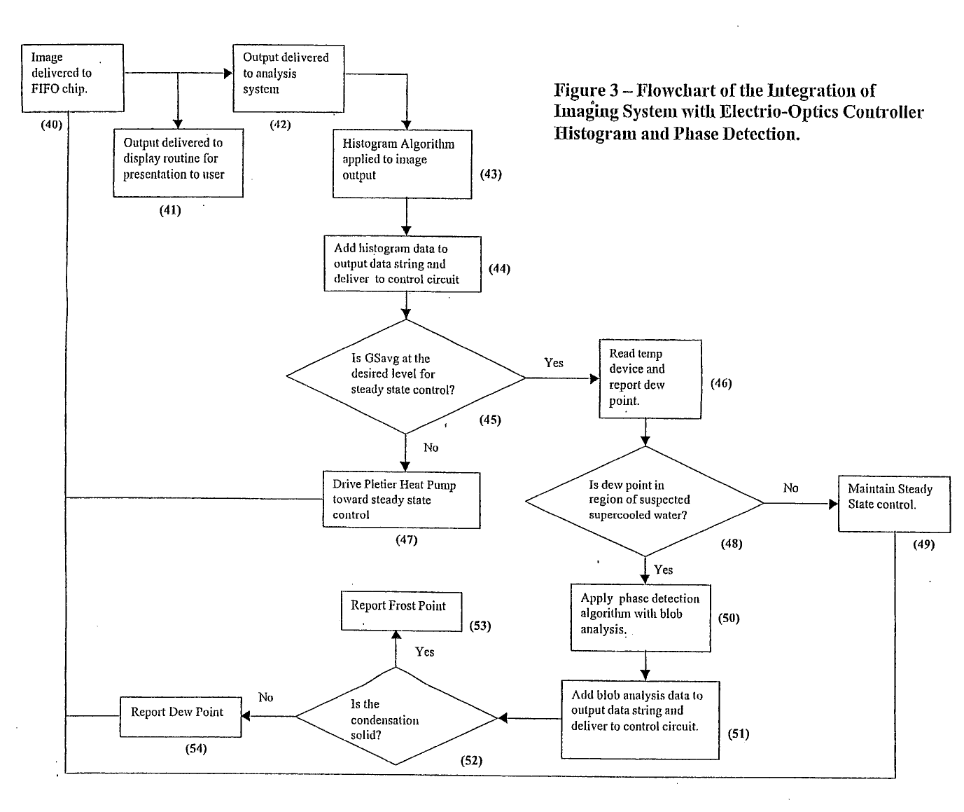

FIG. 3 is a flowchart showing one example of the integration of the output data from the imaging system and subsequent processing by the analysis system with the electro-optic control circuit from one example of the existing art. This flowchart is not intended to present detail electrical control theory as this has been presented in one or more prior art patents (Harding, U.S. Pat. No. 4,216,669). This flowchart is intended to show an example of the integration of the optical system described in this invention with the existing art.

The output data that the imaging system 1 provides is a video signal depicting the region of interest including the condition of the condensation surface 3. The output data is a function of many parameters including the lighting technique of the sample cavity, any filtering or algorithms that may be employed to enhance the video image as well as the actual dew point that is being measured. In addition, the format of the output data depends on the level of processing or analysis that is done to the output of the image sensor prior to being delivered to the control circuit. The output data will depend on whether the technology of the image sensor is analog or digital as well as the resolution of the imaging sensor. Regardless of the format, the common thread is that the output data from the image system will be a video signal, for example raw digital data or a bitmap representing the focal area of the imaging system. If the video signal is analog in nature, one possible option for analysis is to perform an analog to digital conversion of the video signal. The flowchart presented here will describe the use of the output video data from the image system assuming that it is of digital technology or that if of analog or other technology that a conversion has been performed, for example into a raw digital signal.

The delivery of the raw digital signal is also technology that is previously understood in the existing art. The interface between the image system and analysis system may be for example clocked directly with the analysis system located locally to the imaging system, for example as in the existing art of “smart imaging sensors” or it may be clocked directly to a remotely located analysis system, for example an industry standard controller device or PC like device. Additionally, the delivery of output data from the imaging system to the analysis system, either local or remotely located may be, for example handled with FIFO memory where the most recent image is continually stored by the image system and retrieved by the analysis system for further processing. This processing may include the application of analysis algorithms to the digital image for the purpose of data extraction or the application of a software routine to create a visual image to be presented to the end user on for example, a flat panel display. In addition, this processing may be performed by “embedded” algorithms stored within the circuitry of the control circuit and called in a predetermined sequence as required by preset conditions. The processing of the video signal may also be performed by existing art “framegrabbers”. These framegrabbers are typically configured to accept numerous types of video input signals and to provide the user with an interface in which to apply algorithms to the received video signal for the purpose of data extraction from the video signal. Regardless of the method employed, the example presented here is one of many ways in which one skilled in the art of video data delivery and manipulation could accomplish a similar goal.

The technique presented in this embodiment of the invention includes the imaging system comprises for example, a monochrome imaging sensor with resolution of 640×480 pixels. Each pixel within the imaging sensor is described by a digital value of brightness, for example 8 bit where absence of color is depicted by a value of zero and saturation of light is depicted by a value of 255. This monochrome image is delivered as a raw digital image to a FIFO memory chip 40. This raw digital image is then stored momentarily until over written by the next image delivered by the imaging system or the analysis system removes it from the FIFO memory chip for processing, data extraction or displaying the image 41 & 42. Once delivered to the analysis system, and with the ROI previously defined from the start up sequence, the image is analyzed using analysis algorithms, for example a histogram algorithm 43. The histogram algorithm creates a set of statistical data representing the brightness value of each pixel. The analysis circuit then creates an output string of representative values of the histogram, for example the average and standard deviation 44. The data present in the output string is utilized by the electro optical control circuit to manipulate the Pettier thermoelectric cooler to heat and or cool until the predetermined control values are reached. Once the predetermined values are delivered by the output string, the temperature is read from the temperature device 46 and reported to the system as the dew point of the sample gas being measured.

The next step performed by the analysis system is to check to see if the reported dew point is within a predetermined temperature region where supercooled water is known to exist 48. Supercooled water is a kinetic phase of liquid water that exists below the bulk freezing point of 0° C. and can theoretically exist as low as −40° C. Because of the vapor pressure differences between water vapor over liquid water and water vapor over solid ice, accurate measurements require the differentiation. The inability of existing art to be able to distinguish the phase of the condensation within this temperature range can lead to extended steady state response times as well as measurement error. If the reported dew point is with this predetermined range, then the output image from the image sensor will be analyzed with additional algorithm(s) to determine the phase of the condensation, for example the blob analysis algorithm 50. The blob analysis algorithm allows the ROI to be interrogated at the pixel level for groups of pixels that contain certain characteristics for example brightness, shape, size, quantity as well as other combination of geometric properties etc. These parameters of the identified “blobs” are added to the output string along with the statistical values from the histogram algorithm and are delivered to the control circuit 51. Since it is well understood in existing art how different phases of condensation form on mirror surfaces the phase of the condensation can de determined from the parameters delivered in the output string by the blob analysis algorithm. If the output string describes frozen condensation 52 then the instrument will report frost point 53. Otherwise if the data describes liquid condensation then the instrument will report the dew point 54. This technique will allow the invention described here to make fast, accurate measurements in this temperature region that has caused problems in the prior art systems.

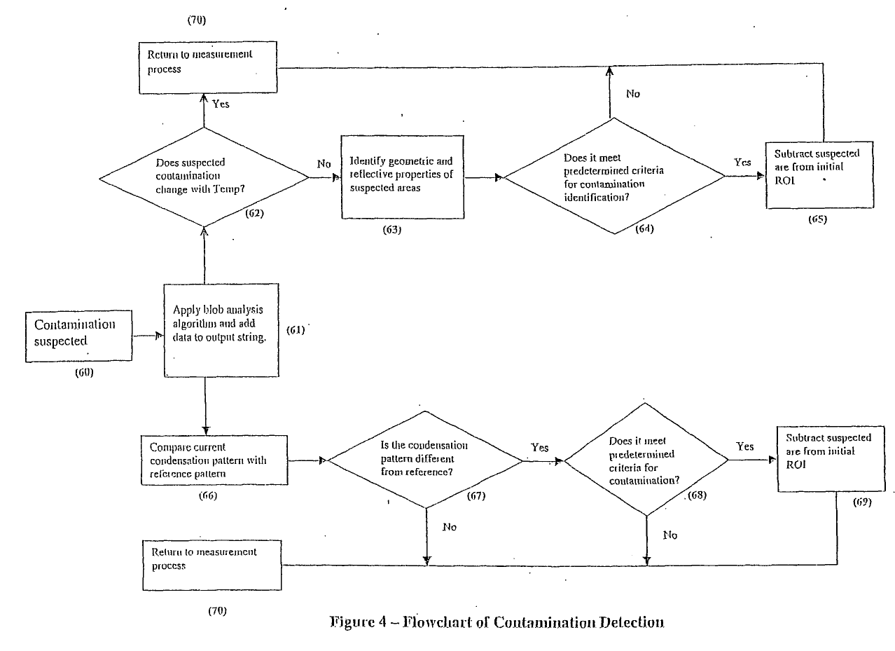

FIG. 4 describes the process of handling contamination on the condensation surface. This topic in the prior art systems has received a lot of attention over the years. Contamination has long been considered the Achilles heel of condensing hygrometers and there have been many ways presented in the art to handle its presence. See for example, Coriolis, U.S. Pat. No. 2,893,237, Bisberg, U.S. Pat. No. 3,623,356, Harding, U.S. Pat. No. 4,216,669, Dosoretz, U.S. Pat. No. 4,629,333, and Schwiesow, U.S. Pat. No. 5,227,636. The earliest existing art describes flooding the mirror with condensate to absorb soluble contaminants followed by rapid heating to evaporate the contaminants. Other existing art describes flooding the condensation surface and forcing the contaminants to coalesce and then evaporating the condensate to redistribute the contaminants into localized dense pockets rather than being uniformly distributed across the mirror surface. Additional existing art presents dual optical devices with wavelengths tuned to be adsorbed either by the condensation or contaminants. The mechanisms of contamination compensation have all made incremental improvements in the way that contaminants are handled by condensing hygrometers. The common theme among the majority of these mechanisms is that their source of information is limited to the accumulation of reflected light from the entire area of the condensation surface.

The process described in this invention improves upon the existing art by utilizing the ability of the imaging technology to geometrically divide the condensation surface into many thousands of smaller regions and to analyze the data that describes each of these regions. The size of the geometric resolution is limited only by the resolution of the imaging sensor. If for example a 640×480 pixel imaging sensor is analyzing a condensation surface that is 0.125″ in diameter then the system is able to resolve an area 7.5 microns by 10 microns. In addition to being able to resolve this area, the described invention can also repeatedly locate and/or track the same location in time.

Utilizing this technique along with analysis algorithm(s), for example blob analysis 61 the proposed invention identifies “blobs” whose geometric and or reflective properties do not change with surface temperature 62. After identification and analyzing the properties of these contamination “blobs” for predetermined periods of time 63 and identifying the “blobs” as contamination 64, the area that they occupy on the condensation surface can be removed from the analyzed region of interest 65. This process of contamination identification and removal from the analyzed area along with auto cleaning processes present in the existing art will greatly reduce the required interval of user maintenance.

An additional area of concern is soluble contamination. Soluble contamination has the ability to leave film deposits of solute behind on the condensation surface and can lead to erroneous dew point readings. Nucleation effects on condensation are well understood in the existing art and are governed by the laws of Gibb's free energy. Nucleation dictates that there are preferential areas on a surface where condensation will form first due to a lower barrier of formation. The presence of contaminant film on the condensation surface will alter the surface energy of the surface causing the condensation formation sequence to change. By understanding the condensation formation history of the contamination free condensation surface 66, any deviations identified by the “blob” algorithm would tend to indicate the presence of film contamination 67 or some other means by which the surface energy of the condensation surface has been altered 68. This type of contamination identification can be utilized trigger a service requirement eliminating the potential for erroneous measurements. The information describing these contamination “blobs” is added to the output string from the image system and presented to the control circuit for removal from the defined ROI 69.

As described above, the concept of using an imaging system along with an analysis system to create and subsequently process video images has been presented. One of the goals of this invention has been to improve the existing art present in condensation detection systems. Specifically, the use of digital image sensors for image generation and the application of edge detection, histogram and blob analysis algorithms for the purpose of data extraction and subsequent processing and control by a control circuit. The overall objective of this document is to present the concept of image analysis and data extraction for the purpose of condensation detection. It is obvious to those skilled in the art of condensation detection and/or image processing that there are an infinite number of possibilities in which this same concept can be implemented. The number of possibilities is only limited by the current or future availability of image processing algorithms. The intention of this document is to describe the general concept as well as to present one of a number of options in achieving improvement to the existing art of condensation detection.

The present invention has been described in detail, including the preferred embodiments thereof. However, it will be appreciated that those skilled in the art, upon consideration of the present disclosure, may make modifications and/or improvements on this invention and still be within the scope and spirit of this invention as set forth in the following claims.

What is claimed is:

1. An image processing apparatus for gas analysis, comprising:
a central body containing a chamber having two ends, with a condensation surface located at one end of the chamber, the central body having at least one input channel to the chamber for introduction of a gas to be analyzed;
an image-capturing device located at the opposed end of the chamber from the condensation surface; and
a processing device for analyzing captured images of the condensation surface.

2. The image processing apparatus of claim 1, wherein the condensation surface is a mirror with a reflective surface facing the lens of the image-capturing device.

3. The image processing apparatus of claim 1, wherein the processing device is a microprocessor/microcomputer.

4. The image processing apparatus of claim 1, further comprising an automated control system.

5. The image processing apparatus of claim 1, further comprising a temperature sensor located near the condensation surface.

6. The image processing apparatus of claim 5, wherein the temperature sensor is contained in a base assembly located beneath the central body.

7. The image processing apparatus of claim 6, wherein the temperature sensor is located beneath the condensation surface.

8. The image processing apparatus of claim 7, further comprising a heat pump located near the temperature sensor and the condensation surface.

9. The image processing apparatus of claim 8, wherein the heat pump is contained in a base assembly located beneath the central body.

10. The image processing apparatus of claim 8, wherein the heat pump is located beneath the temperature sensor.

11. The image processing apparatus of claim 1, further comprising a cooling plate.

12. The image processing apparatus of claim 11, wherein the cooling plate is located beneath the heat pump.

13. The image processing apparatus of claim 1, wherein the image-capturing device is mounted to a pressure cover.

14. The image processing apparatus of claim 13, wherein the pressure cover forms a seal when engaged with the central body.

15. The image processing apparatus of claim 13, further comprising inputs from the temperature sensor.

16. The image processing apparatus of claim 13, further comprising inputs from the image-capturing device.

17. The image processing apparatus of claim 13, further comprising outputs to the image-capturing device and the heat pump.

18. An image processing apparatus for gas analysis, comprising:
a central body containing a chamber having two ends, with a condensation surface located at one end of the chamber, the condensation surface having a reflective surface facing the lens of the image-capturing device, the central body having at least one input channel to the chamber for introduction of a gas to be analyzed;
an image-capturing device located at the opposed end of the chamber from the condensation surface, the image-capturing device being mounted to a cover, the cover forming a seal when engaged with the central body, the cover having a sealed electrical connector through which output wires of the image-capturing device pass;
a temperature sensor located near the condensation surface,
a heat pump located near the temperature sensor,
a cooling plate located near the heat pump, and
a processing device for analyzing captured images of the condensation surface.

19. An image processing apparatus for dew point analysis, comprising:
a central body containing a chamber having two ends, with a condensation surface having a top side and an underside, the condensation surface being located at one end of the chamber, the central body having at least one input to the chamber for introduction of a gas to be analyzed, the condensation surface having a reflective mirrored surface facing the lens of the image-capturing device;
an image-capturing device located at the opposed ends of the chamber from the condensation surface, the image-capturing device being mounted to a pressure cover that forms a seal when engaged with the central body, the pressure cover having a sealed electrical connector through which output wires of the image-capturing device pass;
a base assembly having a temperature sensor, a heat pump and a cooling plate, the temperature sensor being located beneath the underside of the condensation surface, the heat pump being located beneath the temperature sensor, the cooling plate being located beneath the heat pump; and
a processing device for analyzing captured images of the condensation surface, the processing device having inputs from the temperature sensor and image-capturing device; the control system having outputs to the image-capturing device and the heat pump.
